(19) United States
(12) Patent Application Publication
(10) Pub. No.: US 2013/0212049 A1
(43) Pub. Date: Aug. 15, 2013

(54) Machine Evolutionary Behavior by Embedded Collaborative Learning Engine (eCLE)

(71) Applicant: American GNC Corporation, (US)

(72) Inventor: Francisco J. Maldonado, Simi Valley, CA (US)

(73) Assignee: American GNC Corporation, Simi Valley, CA (US)

(21) Appl. No.: 13/767,484

(22) Filed: Feb. 14, 2013

Related U.S. Application Data
(60) Provisional application No. 61/633,674, filed on Feb. 15, 2012.

(51) Int. Cl. G06N 99/00

(52) U.S. Cl. CPC G06N 99/005
USPC 706/12

(57) ABSTRACT

This patent develops and demonstrates the technology required for constructing machine evolutionary behavior within systems to enable evolving learning capability for autonomous recognition of new emerging behaviors. A purpose of this technology is to provide a formal methodology and implementation for adding new knowledge, which results from the automated recognition of new patterns (behaviors) within systems. Key characteristic of the “Machine Evolutionary Behavior by Embedded Collaborative Learning engine” consist on operating with an ensemble of learning paradigms, which when instantiated work in a collaborative way. The resulting framework compiles the inherent advantages of the involved methods, but also a synergetic behavior is obtained when working in a collaborative fashion.

### CROSS REFERENCE OF RELATED APPLICATION

This is a regular application of a provisional application having an application number of 61/633,674 and a tiling date of Feb. 15, 2012. The contents of the specification, including any intervening amendments thereto, are incorporated herein by reference.

### BACKGROUND OF THE PRESENT INVENTION

1. Field of Invention

The present invention relates to a method for embedding Machine Evolutionary Behavior in systems. The method has the capability to be embedded in any application domain that involves: (a) pattern recognition; (b) operation under uncertainly; (c) automated recognition and systematic processing of emerging behaviors; and (d) adding new knowledge in the target system. Pattern recognition can be achieved by applying different methodologies and algorithms. That is the case of supervised learning where a characterization process can be conducted by working with available data for designing a system that can recognize the involved characterized classes (patterns). The drawback of such kind of systems is the lack of automated classification generalization since they can achieve high performance but working only with the characterized classes. This means that when deployed the system and operating under conditions not included in the characterization process then the system will not able to treat the related data properly for flagging, identifying, labeling, and embedding the new knowledge to the target system (an additional class, the “unknown class”, could be included but this would not provide any insight about the nature of the new emerging behavior, i.e. any uncharacterized behavior would be (a) handled in the same way and (b) assigned to the same “unknown class”). Uncertainty refers to the fact that in many applications is not possible to characterize every possible class (pattern). For example simulations (models), laboratory testing (emulation of system operational conditions), and datalogs processing (containing information about a representative subset operational scenarios) of machinery's subsystems can be conducted for characterizing a baseline of patterns (for example normal and a set of faulty operational conditions in health monitoring applications). Even that this step is fundamental and relevant in applications, actually when deployed the to system in many cases not characterized patterns may emerge (uncertain behaviors not known in the laboratory characterization process). Automated recognition and systematic processing of emerging behaviors (patterns) is a distinctive eCLE feature when compared to the case where the system is designed by agglomeration of learning paradigms. Not only recognition capability of emerging behaviors is enough for providing Machine Evolutionary Behavior, but also a systematic methodology for (a) identifying relations among emerging behaviors and the already known ones (from traditional pattern recognition) as well as (b) expanding in an autonomous way machine's knowledge for conducting pattern recognition. In this way after automated recognition and systematic processing of emerging behaviors (patterns) the proposed methodology produce the Machine Evolutionary Behavior by adding knew knowledge (obtaining working under uncertainty) to the baseline available one (from the classifier design process by traditional techniques to conduct pattern recognition). In this way synergy among the involved learning schemes and collaborative behavior is generated resulting in a more powerful learning engine than that obtained by applying independent versions (or agglomeration) of each learning types.

2. Description of Related Arts

Related with the scope to this novel method is the case where Genetic Algorithms (GA) have been used for performing training and adjusting the Artificial Neural Network (ANN) topology. The resulting schemes can be classified as Evolutionary Algorithm. Drawbacks of using GA is the computational load, implying extended execution time. Also the design of ANN by GA defines a complete different scheme to the one addressed in this patent. Considering the state-of-the-art classifier design techniques, the eCLE differs also from established methods that include: (a) Support Vector Machines; (b) statistical techniques (Bayesian Networks); (c) instance based learners (such as k-Nearest Neighbour, nearest neighbour); and (d) ANN (such as Radial Bases Functions and Multilayer Perceptron). Classification techniques also include logical/symbolic methods addressed in form of decision trees. A breakthrough and key difference between these type of paradigms with the eCLE is the fact that it can treat in a systematic way new knowledge to provide a machine learning evolution to strategy by synergetic operation of supervised and unsupervised learning techniques enabled by hybrid learning.

### SUMMARY OF THE PRESENT INVENTION

This patent documents the development and demonstration of a Collaborative Learning Scheme capable of compiling unsupervised, supervised, and hybrid paradigms to form an Evolutionary Algorithm to generate new knowledge building upon already available one. A key characteristic and strength of the documented method is to blend strengths of the involved learning paradigms. In this way, stability and embedding already available knowledge can be achieved by supervised learning. Then unsupervised clustering methods can provide sensitivity for recognizing new emerging behaviors, characterize them in an autonomous way (by finding prototype vectors, i.e. characteristic feature vectors that identify a candidate class), and after this to enable adding the new obtained knowledge. Both schemes can be combined in a synergetic way to obtain Machine Evolutionary Behavior by Embedded Collaborative Learning Engine (eCLE). To achieve this a hybrid learning scheme provide a framework for fusing machine's knowledge obtained from the supervised (initially available one) an unsupervised learning (dynamically generated from new emerging machine behaviors). In this way, Machine Evolutionary Behavior can be embedded for treating in a systematic way system uncertainty by: (a) recognition of new patterns (which can corresponds to new classes or subclasses); (b) forming autonomously relations among them (identification of the subclasses that belong to a single class from the unsupervised clustering); and (c) mapping to already characterized patterns (finding relations between knowledge obtained from both learning paradigms).

It is an objective of the present invention to provide a methodology for fusing knowledge generated by supervised learning with the one obtained by unsupervised techniques.

It is still another objective of this invention to provide a real time method for identifying relations among classes and subclasses obtained by unsupervised learning by taking advantage of available knowledge in an autonomous way.

It is another objective of this invention to provide a method for identifying in an autonomous way relations between classes and subclasses obtained from unsupervised learning with classes and subclasses obtained supervised techniques (baseline pattern recognition obtained by characterization process).

It is a further objective of this invention to provide a systematic processing framework for identifying and characterizing emerging behaviors (i.e. patterns or uncharacterized classes/clusters) for expanding knowledge database (i.e. expanding the recognition capability of the core classes set by embedding evolving learning capability in order to be able to identify new classes different to the ones contained in the initial core set).

Another objective of this invention is to provide a more powerful pattern recognition scheme to the one obtained by agglomeration of classification methods. Knowledge obtained from the involved learning paradigms is fused within the eCLE framework generating a synergetic behavior.

Additional advantages and features of the invention will become apparent from the description which follows, and may be realized by means of the instrumentalities and combinations particular point out in the appended claims.

According to the present invention, the foregoing and other objects and advantages are attained by a methodology for generation of Collaborative Learning Behavior by forming an ensemble of learning paradigms consisting in a LVQ Network 60 including unsupervised learning 30 and supervised learning 20, comprising the steps oft (i) sharing available knowledge from involved learning paradigms; (ii) identifying a new behavior by unsupervised clustering and determining a new valid behavior; and (iii) systematically embedding the new valid behavior within a framework for expanding pattern recognition capability in an autonomous way.

In accordance with another aspect of the invention, the present invention comprises a system of Embedded Collaborative Learning Engine (eCLE) comprising a supervised learning block, a unsupervised learning block and an LVQ network, comprising an initialization process which includes the following steps:

(a) defining a supervised classifier 22 to perform classification for a subset formed by known characterized patterns after pattern/class characterization, wherein the universe is considered as the set of all possible patterns in a system including characterized and non characterized ones, wherein an initial value of M₂ is defined by the number of elements in the subset, wherein the supervised classifier 22 is designed by an online learning technique; (b) then performing unsupervised clustering by an unsupervised clustering algorithm which is embedded and applied to a training data file for the subset, thereby unsupervised and supervised classifiers are obtained; (c) obtaining eCLE kernel in a dynamic and autonomous way through the LVQ network 60, wherein the LVQ network is arranged for fusing knowledge and providing a framework for finding interrelations among classes, subclasses and available knowledge such that interrelations within unsupervised clusters and mapping to known classes from supervised learning can be identified for initializing the kernel, wherein new emerging relations is identified and added through a framework provided by the kernel by unsupervised clustering in unsupervised learning block in a systematic way, thereby the system is capable of providing evolving behavior within the system.

In accordance with another aspect of the invention, the present invention comprises a method of Embedded Collaborative Learning Engine (eCLE) which comprises a supervised learning block, an unsupervised learning block and an LVQ network, comprising the steps of: (a) transferring available knowledge within a system through supervised learning, therefore available knowledge about classes and patterns is obtained; (b) recognizing new clusters through unsupervised learning which allows cluster identification and characterization; and (c) enabling autonomous learning and adaptation through embedding fast on-line learning algorithms such that a kernel with a plurality of preset learning schemes which includes unsupervised, supervised, and hybrid learning schemes can be triggered and executed within a generalized framework, thereby an efficient scheme for enabling autonomous system evolution can be selectively provided.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a diagram illustrating the structure and components of the Embedded Collaborative Learning Engine (eCLE) according to a preferred embodiment of the present invention.

FIG. 2 is a diagram illustrating the operational states of the eCLE.

FIG. 3 is a diagram illustrating the eCLE process flow during normal operation (classification and adaptation).

FIG. 4 is a diagram illustrating the structure of the Linear Vector Quantization (LVQ) Neural Network used in the eCLE to fuse knowledge and providing to an interface between unsupervised and supervised learning algorithms and respective classifiers.

FIG. 5 is a diagram illustrating the structure of the Competitive Neural Network (CNN) used as example of unsupervised clustering for describing the eCLE scheme.

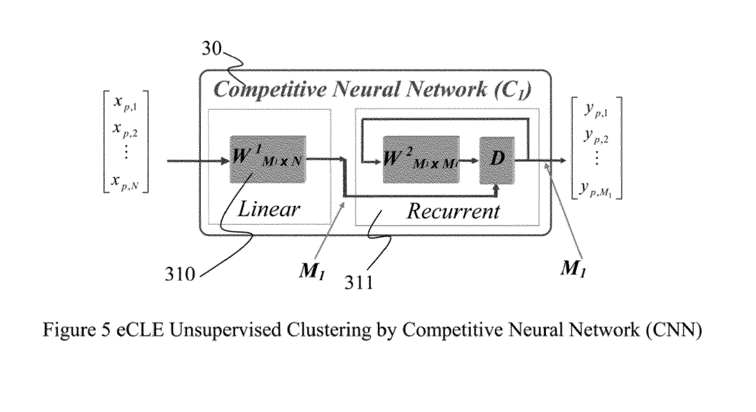

FIG. 6 is a diagram illustrating the structure of the “Cluster Histogram Matrix” (H matrix) that is used to establish dynamically relations among classes/subclasses (clusters) from unsupervised learning (rows) and known classes (columns KC) from supervised learning.

### DETAILED DESCRIPTION OF THE PREFERRED EMBODIMENT

By conducting laboratory testing, most representative classes can be characterized (for example common and critical failures when applied in the context of Health Monitoring systems). However, in many cases when considering uncertainties associated with actual operational conditions in systems (for example: diagnostic systems in aerospace applications; or an extreme case, systems in autonomous planetary exploration), there are always conditions which cannot be known a-priori. Therefore, a reliable technology to adapt and enable system operation under uncertainty (unknown conditions), capable to be embedded for generation of dynamically evolving knowledge to in machines is a desired capability in many applications. The eCLE method is based on three facts:

1. Supervised learning provides a reliable mechanism for transferring available knowledge within a system. Considering pattern recognition, in many applications knowledge is available about the classes/patterns that have to be clustered, which is effectively handled using supervised learning.

2. Unsupervised learning provides high sensitivity for recognizing new clusters. This characteristic allows for cluster identification and characterization. However, it also means that the unsupervised process may be very sensitive to the quality of the input data, learning parameters, and transitory conditions.

3. Embedded fast on-line learning algorithms enable autonomous learning and adaptation. A kernel with a set of learning schemes (unsupervised, supervised, and hybrid) that can be triggered and executed within a generalized framework provides an efficient scheme for enabling autonomous system evolution.

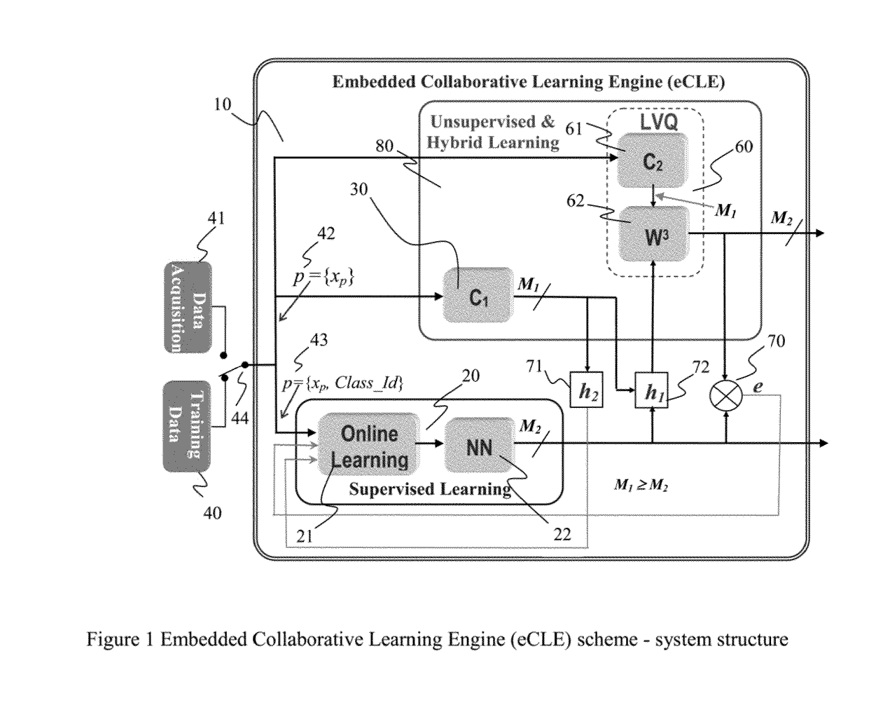

As shown in FIG. 1, the embedded collaborative learning scheme (eCLE) 10, is a more powerful learning engine than that obtained by applying independent versions of each learning type. The eCLE 10 process involves: (a) embedding knowledge by supervised learning 20; (b) performing unsupervised clustering 30; (c) transferring embedded knowledge to the unsupervised subsystem for optimizing unsupervised learning and for defining relations among clusters by using hybrid learning 60; and (d) operating in a collaborative fashion for blending both paradigms within a common generalized framework to achieve autonomous evolution. Steps “a” and “b” (lines 1 and 2 in page 8) operate in parallel over the same training data 40 (i.e. same domain) with the difference being the nature of the learning algorithms. For supervised learning the pattern format 43 will consist on an input vector (xₚ) and class II) as shown to below,

$${p}_{p} = \{ {x}_{p} , Class\_Id \} = \{ [ \begin{matrix}{x}_{p , 1} \\ {x}_{p , 2} \\ ⋮ \\ {x}_{p , N}\end{matrix} ] , Class\_Id \} \qquad ( 1 )$$

and only the input feature vector xₚ 42 in the case of unsupervised learning.

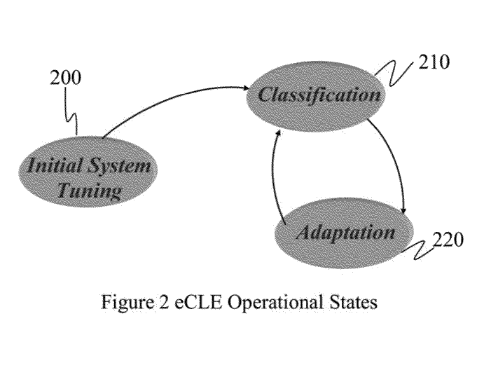

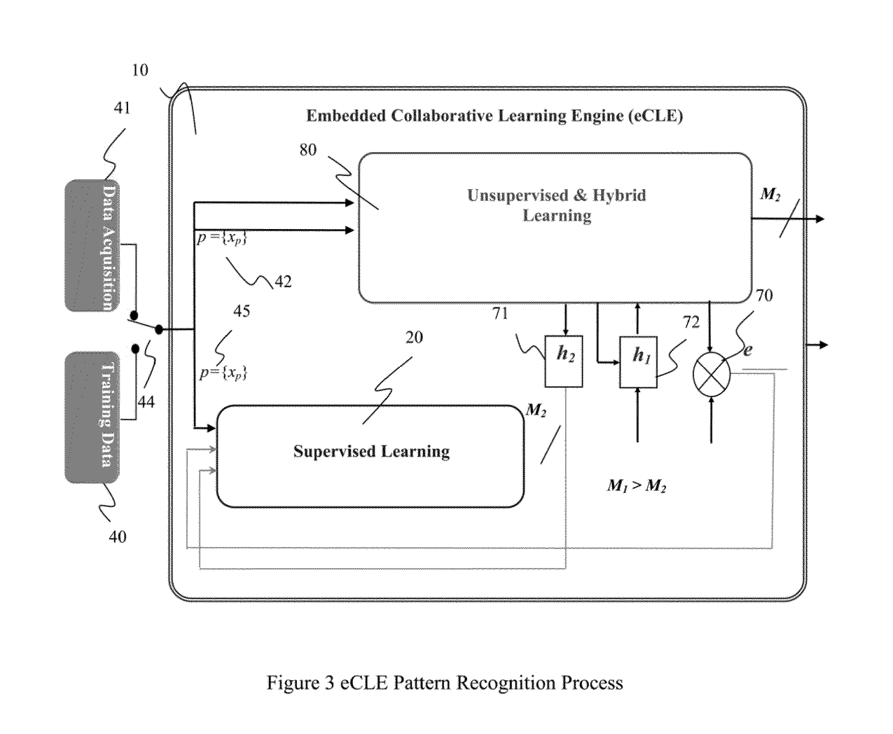

The eCLE 10 operates according to the states defined in FIG. 2. In the “Initial System Tuning” state 200 the blocks that form the eCLE 10 are trained to provide a system core (supervised and unsupervised learning) that learns to recognize known and characterized failures. To describe the eCLE 10 methodology it is used: (a) the Multilayer Perceptron (MLP) 22 and related learning algorithms 21 for implementation of the supervised learning block 20 and (b) a Competitive Neural Network (CNN) 30 and Kohonen learning for implementing the unsupervised block. Other methods can be considered for the realization of these blocks (such as Radial Bases Functions or available well stabilized unsupervised clustering algorithms). Considering this last and being in the Initial System Tuning state then available system information is used for designing (1) classifier 22 (such as a Multilayer Perceptron, MLP) by supervised learning 21; (2) second classifier 30 (such as CNN); and a LVQ network 60. In this way, at the end of the state both classifiers (22 and 30) and the LVQ 60 network are capable of performing Pattern Recognition (Classification) over known behaviors. In this redundant scheme, the diagnostic results should provide the same output (from M₂ possible classes, the initial subset) for characterized failures. After the “Initial System Tuning” state 200, the eCLE 10 goes to the “Classification” state 210 where by using the system core, pattern recognition is conducted by the trained classifiers (60 and 22). The processing flow is depicted in FIG. 3, where a difference with the Initial System Tuning state is the input pattern (switch 44 position is moved upward for clarification purpose) that consist only in feature vectors (42 and 45 without containing any class identifier) feeding both the Unsupervised and Hybrid Learning block 80 as well as the Supervised Learning block 20. In parallel the CNN 30 is processing input vectors 42 in the background. When to performing classification 210, two conditions are tracked for starting the adaptation process (expanding the networks or learning updating): (1) diagnostic errors (generated by comparator 70 processing the LVQ 60 and Supervised Block 20 outputs) and (2) when finding a new valid cluster (from unsupervised classifier 30). When there is either (a) a recurrent difference in the classification result between the LVQ 60 and Supervised Block 20 or (b) a new no characterized pattern is detected by unsupervised learning (from function h₂ output 71), the system goes to the “Adaptation” state 220. In the adaptation state according to the current condition, schemes are selected and executed for adapting the eCLE 10 (such as network growing and retraining the system).

Instantiation of the eCLE 10 core requires: (c.1) system states definition (for example in the Health Monitoring case, this can be performed by defining failures to be seeded for anomaly characterization (in additional to nominal operation)); (c.2) feature set selection for system state characterization (i.e. the input vector xₚ to define patterns 42 and 43); (c.3) generation of training data for designing the supervised classifier block 22 (for example an MLP) by obtaining pattern 43 sets containing an input feature vector (xₚ) along with a cluster identification ID according to expression (1); and (c.4) generation of training data for designing the unsupervised classifier block 30 (for example a CNN) by obtaining pattern sets containing input feature vector (xₚ) 42.

The evolving collaborative learning kernel is designed by first working with available knowledge (as defined in assumption “c.3”) and using supervised learning 21 to embed knowledge in the resulting ANN 22 by using Training Data 40 obtained from the characterization process. In a second initialization step, unsupervised learning is conducted using input Training Data file features (as defined in assumption “c.4”). At this point, clusters are identified, but their nature and relations among clusters are unknown. Afterwards, information from supervised 20 and unsupervised learning 30 is used to instantiate an LVQ network 60 (hybrid-learning block) for defining relations between classes, subclasses, and the clusters from unsupervised learning. As a result of the initialization process, the LVQ block 60 blends knowledge between the supervised 20 and unsupervised subsystems 30 to find autonomously relations and the nature of each to cluster (where for example in the case of health monitoring, clusters will correspond to classes and subclasses that should be mapped to failures and nominal system operation condition). The LVQ's Output Layer (matrix) 62 defines relations between subclasses and classes from unsupervised learning 30 with the ones from supervised learning 20. Thus, clusters are completely defined (nature and relations) and mapped to neurons in the supervised networks. After initialization 200, pattern recognition can be performed by the eCLE by processing on-line data 41 (as depicted in FIG. 3). Also during the classification state 210 new patterns (emerging ones) can be identified from unsupervised learning 30. Operator h₂ 71 detects when a new cluster has been obtained in a recurrent way. Then according to the presence of this condition this event starts the adaptation process, where the new cluster information and related data are used for updating the Supervised Learning classifier 22 and updating the matrices in the LVQ 60. Two cases can be distinguish when detecting a new cluster (i) the cluster corresponds to a subclass of an already know class; or (ii) the cluster does not belong to an already known class. In the first case M₂ remains the same and the supervised classifier 22 is retrained for including the new cluster within an already known class. In the LVQ 60 then C₂ 61 is expanded (and M₁ is incremented by one) to store the new prototype vector in the input linear matrix. W³ 62 adds a new column for handling the new cluster. The new cluster is fully defined since characteristics feature values (elements of the prototype vector) are obtained (from unsupervised learning) and since is a subclass of an already known class the nature of the cluster (for example type of failure or nominal state in the case of health monitoring) is also known. In the second case M₂ and M₁ are incremented by one. The output layer of the supervised classifier 22 (and corresponding structures) is expanded to handle the new class. Then a new prototype vector is added to the LVQ competitive layer C₂ 61 containing information of the new identified cluster. Finally W³ 62 is increased by a row and a column for adding the information of the new class linked to the new cluster.

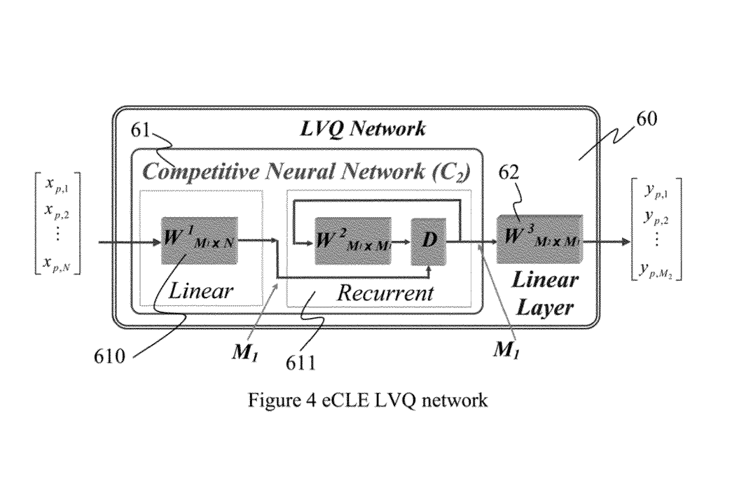

The eCLE 10 applies an optional hybrid learning framework type algorithm after creating a LVQ NN 60 in a dynamic and autonomous way. The LVQ is used for defining cluster properties and enhancing learning (obtaining the LVQ network 60 implies an additional learning step that reinforce the results obtained by unsupervised learning 30). Typical LVQ learning implies: (a) using the supervised training data; (b) applying the Kohonen learning rule; and (c) working with the blocks shown in FIG. 4. FIG. 4 depicts the typical LVQ configuration where a input Linear Layer 610 is used for obtaining prototype vectors that identify each cluster. Then the linear layer 610 output (obtained by multiplying W¹·xₚ) feeds competitive layer 611 whose function is to determine which prototype vector has the highest correlation with the input vector. According to this, a single element in the output vector of the recurrent layer is set to one and the rest vector's elements are set to zero. There are different ways to perform this operation: for example in FIG. 4 is shown a recurrent layer 611 to achieve this. The same result can be obtained by software where the element with the biggest value is determined and used to set the output of the Competitive Neural Network C₂ 61. This output then is processed by the linear layer W³ to map subclasses with classes. In the learning step each pattern (from the supervised process) is input to the LVQ and then according to the winner neuron then its corresponding prototype vector is updated by applying the Kohonen learning rule.

The eCLE works with the same LVQ network structure but uses a different instantiation process (described in the following paragraphs). Then the LVQ network is used as a method for fusing knowledge obtained from the unsupervised learning and supervised learning blocks. Basically the LVQ's CNN weights 610 provide a mechanism for transferring unsupervised learning knowledge (by storing prototype vectors obtained from unsupervised clustering) and then by using the LVQ's Output Layer (matrix) 62 structure relations among clusters and known conditions from supervised learning are created. In the LVQ's Output Layer matrix (FIG. 4), each row is assigned to a class and each column to a subclass. The Linear Layer W³ 62 processes CNN C₂ 61 outputs, which are represented as a vector with M₁ elements. During instantiation of the eCLE 10 kernel, elements in the LVQ's Output Layer matrix take a value of 0 or 1 to include subclasses (columns) in the classes (rows). Afterwards, the engine drives network growth and unsupervised learning in a stable and collaborative way, and the matrix is updated. New information from unsupervised learning is used for updating the supervised block.

Implementation Procedure.

A detailed description of the implementation procedure is addressed in this section. The method is exemplified by using a Competitive Neural Network (as a method for providing unsupervised clustering block 30) and Multilayer Perceptron (as method for providing supervised classifier block 22). Several realization options can be found in the is literature for performing unsupervised clustering (learning algorithms as well as other network types such as RBF). In the case of unsupervised clustering the CNN C₁ (shown in FIG. 4) is used in the eCLE 10 description. The CNN C₁ is formed by a linear layer 310 and a competitive layer 311 (labeled as Recurrent layer FIG. 4). The CNN C₁ operates in the same way as the LVQ's C₂ layer (defined in lines 7 to 15 in page 10). It provides unsupervised clustering capability but it does not allow defining relations among classes and subclasses from unsupervised learning and neither mapping relations with available knowledge (supervised learning). However, its compatibility for identifying new clusters is exploited within the eCLE 10 scheme. In the description of the eCLE 10 is assumed the use of the Kohonen Learning Rule for training the CNN C₁.

Unsupervised Clustering by competitive learning (i.e. competitive neural network) presents the following two drawbacks:

1. Even though the discovered clusters correspond to valid classes and subclasses (after the learning step, every row in the linear layer 310 defines a prototype vector (where each element contain characteristic features values) that is associated with a class and subclass and then identification can be achieved) the algorithms by themselves does not provide a method for identifying to which actual class or subclass a given active output neuron corresponds to.

2. Competitive networks are very sensitive to the input data quality. This is a good characteristic for detecting new conditions, but at the same time it can lead to unstable conditions when growing the network. A more stable method is thus necessary that maintains the advantages of unsupervised learning but provides stable behavior.

To work with these drawbacks, a scheme compiling supervised 20 and unsupervised 30 learning capability blended through hybrid learning framework (modified LVQ paradigm 60) is used to form the eCLE 10. In this scheme the LVQ network 60 is leveraged as it serves as an interface between both learning types. Because the first LVQ layer 61 is basically the same as a competitive network 30, in the eCLE kernel 10 a copy of the competitive network C₁ 30 (shown in FIG. 1) is utilized for initializing C₂ 61 in the LVQ 60 input linear layer (e.g. layer with W¹ 610 in FIG. 4). In this way, the clustering capability of unsupervised learning is used to identify initial subclasses and/or classes by working in the domain of characterized failures. After training C₁ 30, the LVQ input linear layer 61 is set according to the training results (identified prototype vectors by unsupervised learning 30). Thus, the number of clusters to be processed (unknown when powering the system up, where each one can correspond to a class or subclasses) in the LVQ network is found dynamically. However, identification of the classes and subclasses (although valid clusters, their nature is unknown) Is needed. To dynamically identify classes and subclasses obtained by training C₁ 30 (such that the system itself recognizes their nature), supervised learning is used for mapping. A method that processes classification results from a trained MLP 22 and competitive network C₁ 30 is used for defining connections between the neurons in the LVQ input competitive layer 61 (subclasses) and LVQ outputs 62 (classes). At the end, the LVQ network framework 60 is dynamically instantiated by fusing information from both types (20 and 30 of learning algorithms). Once dynamically instantiated the LVQ layers (C₂ 61 and W³ 62) an additional LVQ learning step can be applied for improving classification performance. The LVQ provides the advantages of the competitive network (considering its input layer) and learns to identify classes properly. Therefore, in a dynamic way, a block is instantiated that can be used in a redundant pattern recognition scheme that also allows blending knowledge from supervised and unsupervised paradigms. The implementation of the core system is presented below and demonstrated by using MLP (as supervised technique case) and Competitive Neural Network (CNN, as unsupervised clustering case).

The eCLE 10 is formed by three main blocks: (1) supervised learning 20 (MLP); (2) unsupervised learning 30 (Competitive Network-C₁): and (3) an LVQ network 60. The initialization process involves the following steps:

1. Supervised Training (MLP design). Using available knowledge (sources include: lab testing, data log analysis, etc.), data is generated for working with known classes (for example failures and nominal condition in the case of health monitoring). According to the application domain a characterization process is conducted where an initial set of classes is identified (M) and feature selection is conducted (i.e. identification of highly correlated parameters with the system states). According to the selected number of feature then the input vector xₚ dimension (N) is known. Then a data training file is generated containing a set of examples (N, patterns 43, containing each one a input vector xₚ and Class_Id as shown in FIG. 1) for training by supervised learning the MLP. The number of classes (M₂) to which the initial set of characterized cases belong to is known (for example in the case of Health Monitoring. M₂ includes both the number of characterized failures (for example seeded in lab testing) and the nominal operation case). In the same context (example) the universe of valid states (which includes all possible nominal operation conditions and all possible anomaly operation conditions, i.e. characterized and not characterized ones) can be defined as Uₛ. The results of this step are: (a) definition of parameters M₂ and N and (b) a Neural Network 22 trained by supervised learning for recognized M₂ characterized classes by processing input vectors (xₚ) containing N selected features.

2. Cluster Identification by a CNN. Using Step 1's training file but disregarding the target desired values in the input patterns (pattern 42 in FIG. 1), the data is processed by unsupervised learning 30. Several methodologies are available for conducting this step. Examples include Kohonen Learning for processing results of competitive networks combined with neighborhood metrics. As a result, an initial cluster set is obtained for working with the characterized failures. M₁ clusters (where each one could correspond to a class or subclass) are identified and characterized (since prototype vectors are obtained at the end of the unsupervised trained step). At this point valid clusters have been obtained but still a mapping with characterized classes from to supervised learning (M₂ classes) shall be conducted. The results of this step are; (a) parameter M₁ that define the number of cluster obtained from unsupervised learning; and (b) Competitive Neural Network (C₁) 30 containing prototype cluster vectors (each one identifying a class or a subclass, which this last is unknown by applying pure unsupervised clustering).

3. LVQ Input Linear Layer Initialization. Using M₁ found in Step 2, and knowing the number of classes (M₂) from supervised learning, matrices are then instantiated for defining the LVQ network structure (topology). In a copying process, the input weight matrix (C₂ 61 with size of M₁×N) elements are initialized with the same values of the weight value's elements of the C₁ 30 active neurons (M₁ neurons). Then, the LVQ output linear weight matrix (W³, with dimension M₃×M₁) is instantiated and set to zero. The results of this step are; (a) obtaining the dimension of LVQ matrixes; (b) by using the obtained LVQ dimensions then the competitive layer C₂ 61 and output layer W; 62 are instantiated and their elements are set to zero; and (c) the LVQ C₂ matrix is initialized by setting it as equal to the C₁ matrix obtained in step 2.

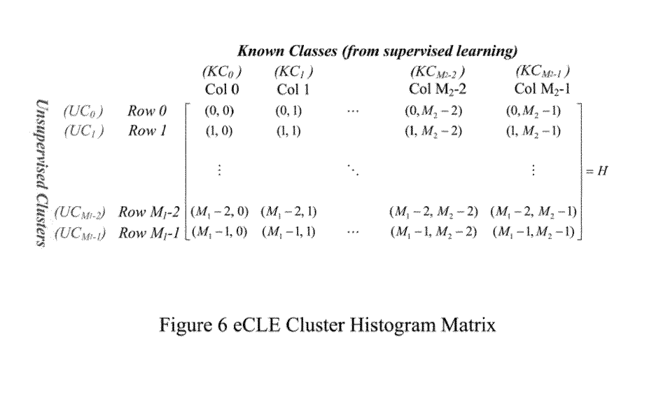

4. Determining in Autonomous and Dynamic Way Relations Among Clusters (from unsupervised learning) to define in the LVQ framework the output layer W³ and classification enhancement by training the resulting LVQ network. The LVQ network is used as an interface between supervised and unsupervised learning. Its configuration and definition is obtained in an autonomous and dynamic fashion to achieve Machine Evolutionary Behavior by providing a framework for mapping relations between clusters (obtained from unsupervised learning) and known behaviors (which are recognized through a classifier designed by supervised techniques). System evolution will produce changes in the LVQ network, which allow unifying machine knowledge in a common framework. In this step connections between LVQ Competitive Neural Network and LVQ Output Neurons are identified in an autonomous way to enable (a) relation identification among unsupervised clusters and (b) mapping with already available knowledge (i.e. already characterized classes, which are identified by the classifier designed though supervised learning). Remarks: (r1) a set of M₁ clusters can be identified by unsupervised learning (where the cluster nature of each one is unknown); (r2) M₂ characterized classes can be identified by supervised learning (where class nature is completely defined); (r3) training has been conducted and proper classifiers are available for performing classification; (r4) LVQ parameters have been obtained dynamically after executing steps 1, 2, and 3 (i.e. then LVQ topology has been defined and the LVQ linear layer C₂ 61 has been initialized); and (r5) a training data file (containing Nᵥ patterns 43) is available with patterns corresponding to the characterized classes. Considering these remarks then the LVQ output matrix can be defined by applying function h₁ 72, which obtains a “Cluster Histogram Matrix” (H). This matrix maps the unsupervised cluster frequency with respect to known classes as shown in FIG. 6. Each row-k of this matrix is mapped with a single output of the unsupervised block, where each output corresponds to the unknown class “k” denoted by UCₖ (the term “unknown” is used in the sense that its nature of the obtained cluster is not defined and with 0≦k<M₁). Each column-q of this matrix is mapped with a known class “q” denoted by KC_{q} (from supervised learning with 0≦q<M₂). Function h₁ can be obtained in the following way: (1) instantiate a matrix with dimension M₁×M₂ (setting all its elements to zero) to contain the “Cluster Histogram” information (i.e. unsupervised cluster frequency in terms of known classes); (2) set the pattern counter (“p”) equal to 0; (3) read the p^{th} pattern from the training data file (from remark “r5”); (4) feed the p* pattern to the MLP 22 (from remark r2 and r3) to determine the class to which the input pattern corresponds to. (5) feed the p^{th} pattern to the CNN 30 (from remark r1 and r3) to determine the unsupervised cluster to which the input pattern corresponds to; (6) increment the element addressed by the MLP class number output (which defines the column number “q”) and the CNN cluster number output (which defines the row number “k”); (7) increment the pattern counter “p”; (8) if p<than Nᵥ go to step “3”, else finish the process. In this way the result of evaluating h₁ 72 (cluster frequency information) can be used for: (i) identifying subclasses and classes within unsupervised clusters; and (ii) also the h₁ 72 values (Cluster Histogram Matrix's information) allows mapping the characterized clusters (as stated in the previous point “i”) with known classes (from supervised learning). Considering step 3 (line 29 in page 13 to line 5 in page 14) with (i) and (ii) (lines 11-15, page 15) then the LVQ's output layer can be completely defined in an autonomous and dynamical way. As stated before each output of the unsupervised block is correlated with each row of the Cluster Histogram Matrix and in a similar way columns in the matrix are related with known classes from supervised learning (although the assignation can be also interchange if desired). When this process is conducted successfully then looking at each column, the elements with values different to zero indicate that the corresponding unsupervised output (i.e. neuron in a CNN associated with the element's row) is classifying a subset of input vectors (whose number of vectors is defined by the frequency value) that corresponds to the class associated with the column. A column can have different elements with a value different of zero, and then the outputs associated with each row are subclasses of the class mapped with the matrix's column. The case when a single row has several elements different to zero is an invalid case since a subclass can be mapped with a single class but not to several classes. Defining the content of the W³ matrix (with size of M₂×M₁ and whose elements were set to zero in Step 3) is performed by the following process: (1) set row number “r” equal to zero; (2) read the “r^{th}” row of the H-Matrix (with size of M₁×M₂); (3) find the position of the element within the row with the highest frequency (and store in variable Max_Element); (4) select row defined by the content of the auxiliary variable “Max_Element” in W³-matrix and set within the row the “r^{th}” element (column) to 1; (5) increment the value of “r”; (6) if “r” is equal to M1 then end the process, else go to step 2 of this process.

After executing these four steps, the LVQ network is dynamically instantiated and the three networks are initialized. Working with the unsupervised learning (in this case a competitive network), a method for identifying new emerging conditions is embedded in the engine. Unsupervised clustering (by CNN C₁ 30) information drives network growing in the LVQ and MLP networks. Knowledge fusion and relation identification among classes, subclasses, and available knowledge is achieved by working with the LVQ. Moreover, with the LVQ, dynamic association between newly emerging behaviors (which will result in an unidentified cluster) and their true nature (association with an actual failure or nominal condition in the health monitoring example) can be performed in the case of identification of new subclasses belonging to already known classes (for example in the case of HM, new symptoms associated with a characterized failure leading to a new valid cluster or stable operation conditions (which can define a new valid cluster) not included in the characterization process). In the case of new classes, this can be incorporated in a systematic way within the eCLE 10 framework (by updating the LVQ and MLP networks in the described implementation). The resulting redundant pattern recognition system is able to detect emerging behavior by tracking: (1) differences in the classifier's output (i.e. differences between the LVQ and MLP outputs for the same input vector xₚ provided by comparator 70, where for example in a HM application would correspond to diagnostic errors) and by (2) applying unsupervised clustering 30 (executed in the CNN C₁ 30 as well as in the LVQ input layer C₂ 61 in a dual fashion) for taking advantage of its sensitivity to identify new behaviors. When a recurrent new condition is identified by function h₂ 71 then a new cluster is defined (by obtaining its prototype vector) and then the supervised classifier 22 and the LVQ 60 are updated. FIG. 1 depicts the resulting blocks (22, 30, 61 and 62) after initialization. Also looking at the figure, a comparator 70 processes both outputs (LVQ 62 and NN 22) for determining pattern recognition errors, which is then fed to the Supervised Learning 20. Information from C₁ 30 and the MLP 22 are processed by a function h₁ 72, to define relations among clusters and available knowledge by computing matrix H. Also information from C₁ 30 is used by h₂ 71, to identify new clusters and starting the adaptation process.

Accordingly, the present invention provides a methodology for generation of Collaborative Learning Behavior by forming an ensemble of learning paradigms consisting in LVQ Artificial Neural Network 60, unsupervised 30, and supervised learning 20. The ensemble shares available knowledge from the involved learning paradigms, is able to identify new behaviors (by unsupervised clustering), and once that a new valid behavior is identified then systematically is embedded within the framework for expanding the pattern recognition capability in an autonomous way.

Preferably, the present invention provides a system which includes a method to generate Machine Evolutionary Behavior and is termed Embedded Collaborative Learning Engine (eCLE) 10.

The eCLE 10 method comprises the main subtasks: (a) After pattern/class characterization a supervised classifier 22 (for example MLP ANN) is designed to perform classification for a subset formed by the known characterized patterns (considering the universe as the set of all possible patterns in the system including characterized and non characterized ones). The number of elements in this subset defines the initial value of M₂. Any on-line learning technique can be applied for designing the is supervised classifier 22; b) Working with the same characterized patterns/classes subset then an unsupervised clustering algorithm can be embedded and applied to the training data file (obtained from the characterization process of the selected application domain) for performing unsupervised clustering. As result of this subtask, an unsupervised classifier and embedded learning algorithm are obtained; c) Once that the unsupervised and supervised classifiers (subtask “a” lines 11 to 17 in paragraph 48 in page 19 and “b” lines 17 to 21 in paragraph 48 in page 19) are obtained, the eCLE 10 kernel is obtained in a dynamic and autonomous way by applying the proposed methodology described in lines 15 in paragraph 43 in page 15 to line 29 in paragraph 44 in pages 15-19, where a LVQ network 60 is used for fusing knowledge and providing a framework for finding interrelations among classes, subclasses, and available knowledge. In this way interrelations within unsupervised clusters and mapping to known classes from supervised learning can be identified for initializing the kernel. Also the kernel provide a framework for adding new emerging relations that can be identified by unsupervised clustering 30 in a systematic way providing in this way evolving behavior within the system.

The eCLE 10 method enable mapping clusters from unsupervised learning to known classes allowing cluster identification (as subclass or class and conducting mapping to known behaviors/classes from supervised learning), which is a capability that makes a difference when compared with pure unsupervised learning results. Emerging behaviors (unsupervised clusters found after the kernel initialization) that corresponds to already characterized classes (i.e. a new subclass has been found) can be identified by the proposed framework. In the case that the new emerging behavior (i.e. a new class have been found) does not correspond to characterized ones (for example a new class not included in the characterization process) this can be inserted within the eCLE 10 framework in a systematic way by expanding the LVQ matrix 60 and retraining the supervised network 22.

The LVQ network 60 is used for interrelating the operation of the unsupervised learning block 30 with the supervised learning block 20.

The LVQ 60 neural network is instantiated and designed within the eCLE 10 scheme in an autonomous and dynamic way. The design of the LVQ network 60 comprising the steps of:

a) Embedding an on-line supervised learning algorithm and design of a supervised classifier (such as MLP design) as described in paragraph 41 from line 12 to line 29 in page 14.

b) Embedding an unsupervised clustering algorithms and design of unsupervised clustering 30 (such as Competitive Neural Network) as described in paragraph 42 from line 1 to line 14 in page 15.

c) From steps “a” and “b” then the LVQ parameters (size of the involved matrixes C₂ 61 and W³ 62) can be obtained and used for instantiating the LVQ matrixes. C₂ 61 process the same amount of inputs as the ones defined in the input vector xₚ and after unsupervised clustering (step b defined paragraph 42 from line 1 to line 14 in page 15) then by knowing the cluster number M the size of the LVQ input matrix is equal to M×N. The LVQ input layer C₂ 61 is initialized by making it equal to the CNN 30. After unsupervised training (step b) also the dimension of the output matrix W³ is M₂×M₁ (where M₂ corresponds to the number of characterized classes and M₁ is the number of clusters from unsupervised training (step b)). The elements of W³ are set to zero.

d) The matrix H (defined lines 27 to 30 in page 14) is obtained and used for finding in an autonomous way relations among clusters and available knowledge by to setting the values of the LVQ's W³ matrix. The content of matrix H is used for identifying clusters as classes or subclasses as well as simultaneously mapping the clusters to know classes (from supervised learning). Elements of W³ 62 are set according to the procedure described from line 15 in paragraph 43 in page 15 to line 29 in paragraph 44 in pages 19.

After obtaining in an autonomous way the LVQ network 60, this one fuse knowledge from the supervised 22 and unsupervised 30 classifiers for performing pattern recognition (i.e. classification capabilities are blended through the LVQ network).

After obtaining in an autonomous way the LVQ network 60, optionally can be enhanced by applying LVQ learning to the resulting network. The system already has learned to recognize cluster considering that the input layer is set equal to the unsupervised classifier (obtained in step b by unsupervised learning addressed in paragraph 42 from line 1 page 15 to line 1 in page 15) and also the output matrix has been set properly (according to the process described in lines 28 page 14 to line 28 page 18). This already trained network can be optionally improved by using the supervised learning data to apply LVQ learning.

After obtaining in an autonomous way the LVQ network 60, this one provides a framework to systematically process new input vectors to perform classification by compilation of techniques.

After obtaining in an autonomous way the LVQ network 60, this one provides a framework to recognize and characterize emerging behaviors (new patterns). Once that a new emerging behavior (new pattern) has been identified and characterized (by unsupervised clustering) the eCLE 10 systematically process this new knowledge to expand dynamically the machine pattern recognition capability generating in this way Machine Evolutionary Behavior.

The eCLE 10 provides after initialization classification capability for a set of characterized classes where (a) the supervised classifier 22 can identify known conditions as well as the (b) LVQ network 60. When unsupervised learning 30 detects a new emerging behavior the eCLE 10 goes to an adaptation stage where the LVQ 60 is expanded and the supervised classifier 22 is retrained.

The eCLE 10 provides a mechanism which results in a more powerful classifier to the one obtained by individual base classifier design (of the involved techniques) or their agglomeration.

The eCLE 10 is not restricted to a specific application domain. The eCLE can be applied to any process that require Machine Evolutionary Behavior meaning the capabilities listed in paragraph 49 (lines 3-13 in page 20) and paragraph 59 (lines 1-6 in page 22). The eCLE can operate under uncertainty and perform. (a) pattern recognition; (b) automated recognition and systematic processing of emerging behaviors; and (c) adding new knowledge in the target system.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A methodology for generation of Collaborative Learning Behavior by forming an ensemble of learning paradigms consisting in a LVQ Network 60 including unsupervised learning 30 and supervised learning 20, comprising the steps of:
(i) sharing available knowledge from involved learning paradigms:
(ii) identifying a new behavior by unsupervised clustering and determining a new valid behavior; and
(iii) systematically embedding the new valid behavior within a framework for expanding pattern recognition capability in an autonomous way.

2. The methodology for generation of Collaborative Learning Behavior according to claim 1, further comprising the step of: generating a Machine Evoluntionary Behavior through an Embedded Collaborative Learning Engine (eCLE) 10 method which comprises the following subtasks:
(a) defining a supervised classifier 22 to perform classification for a subset formed by known characterized patterns after pattern/class characterization, wherein the universe is considered as the set of all possible patterns in a system including characterized and non characterized ones, wherein an initial value of M₂ is defined by the number of elements in the subset, wherein the supervised classifier 22 is designed by an online learning technique, where M₂ is the number of characterized classes;
(b) then performing unsupervised clustering by an unsupervised clustering algorithm which is embedded and applied to a training data file for the subset, thereby unsupervised and supervised classifiers are obtained;
(c) obtaining eCLE kernel in a dynamic and autonomous way through the LVQ network 60,
wherein the LVQ network is arranged for fusing knowledge and providing a framework for finding interrelations among classes, subclasses and available knowledge such that interrelations within unsupervised clusters and mapping to known classes from supervised learning can be identified for initializing the kernel, wherein new emerging relations is identified and added through a framework provided by the kernel by unsupervised clustering in unsupervised learning block in a systematic way, thereby the system is capable of providing evolving behavior within the system.

3. A system of Embedded Collaborative Learning Engine (eCLE) comprising a supervised learning block, a unsupervised learning block and an LVQ network, comprising an initialization process which includes the following steps:
(a) defining a supervised classifier 22 to perform classification for a subset formed by known characterized patterns after pattern/class characterization, wherein the universe is considered as the set of all possible patterns in a system including characterized and non characterized ones, wherein an initial value of M₂ is defined by the number of elements in the subset, wherein the supervised classifier 22 is designed by an online learning technique, where M₂ is the number of characterized classes;
(b) then performing unsupervised clustering by an unsupervised clustering algorithm which is embedded and applied to a training data file for the subset, thereby unsupervised and supervised classifiers are obtained;
(c) obtaining eCLE kernel in a dynamic and autonomous way through the LVQ network 60,
wherein the LVQ network is arranged for fusing knowledge and providing a framework for finding interrelations among classes, subclasses and available knowledge such that interrelations within unsupervised clusters and mapping to known classes from supervised learning can be identified for initializing the kernel, wherein new emerging relations is identified and added through a framework provided by the kernel by unsupervised clustering in unsupervised learning block in a systematic way, thereby the system is capable of providing evolving behavior within the system.

4. The system according to claim 3, further comprising the following steps: mapping clusters from unsupervised learning to known classes, allowing cluster identification as subclass or class and conducting mapping to known behaviors and classes from supervised learning, therefore an emerging behavior found after initialization process corresponds to already characterized classes can be identified by the framework while an emerging behavior found after the initialization process that does not correspond to already characterized classes can be inserted within the eCLE framework in a systematic way by expanding the LVQ matrix of the LVQ network and retraining the supervised network 22 in the supervised learning block.

5. The system according to claim 4, wherein the LVQ network is arranged for interrelating the unsupervised learning block and the supervised learning block.

6. The system according to claim 5, wherein the LVQ network is a LVQ neural network instantiated and designed within the eCLE 10 scheme in an autonomous and dynamic way, wherein the design of the LVQ network comprises the steps of:
(i) embedding a predetermined online supervised learning algorithm and design of a supervised classifier:
(ii) embedding a predetermined unsupervised clustering algorithms and design of unsupervised clustering 30;
(iii) obtaining LVQ parameters for instantiating LVQ matrixes in the LVQ network; and
(iv) obtaining matrix H for finding in an autonomous way relations among clusters and available knowledge by setting the values of the LVQ's W³ matrix in the LVQ network.

7. The system according to claim 6, wherein in step (i), the design of the supervised classifier is a MLP design which utilizes available knowledge to generate data for working with known classes, identifies an initial set of classes (M₂) through a characterization process and conduct feature selection, then an input vector xₚ dimension (N) is known according to selected number of feature and a data training file is generated for training by supervised learning the MLP, wherein the number of classes (M₂) to which the initial set of characterized cases belong to is known, wherein the universe of valid states which includes the characterized and not characterized conditions can be defined as Uₛ, thereby parameters M₂ and N are defined and a Neural Network 22 is trained by supervised learning for recognized M₂ characterized classes by processing input vectors (xₚ) containing N selected features.

8. The system according to claim 6, wherein in step (ii), wherein the design is a Kohonen Learning for processing results of competitive networks combined with neighborhood metrics.

9. The system according to claim 7, wherein in step (iv), content of matrix H is used for identifying clusters as classes or subclasses as well as simultaneously mapping the clusters to know classes from the supervised learning.

10. The system according to claim 9, wherein after the LVQ network 60 is obtained in an autonomous way, pattern recognition is performed through fusing knowledge from the supervised 22 and unsupervised 30 classifiers, thereby classification capabilities are blended through the LVQ network.

11. The system according to claim 10, wherein after the LVQ network 60 is obtained in an autonomous way, the LVQ learning is applied to the resulting network such that the resulting network is improved by using the supervised learning data to apply LVQ learning.

12. The system according to claim 11, wherein after the LVQ network 60 is obtained in an autonomous way, a framework is provided to systematically process new input vectors to perform classification by compilation of techniques.

13. The system according to claim 12, wherein after the LVQ network 60 is obtained in an autonomous way, a framework to recognize and characterize emerging behaviors defining new patterns is provided, thereby once one emerging behavior or one new pattern is identified and characterized by unsupervised clustering, the eCLE 10 systematically processes and defines new knowledge from the emerging behaviors or the new patterns to expand dynamically the machine pattern recognition capability and generating the Machine Evolutionary Behavior.

14. The system according to claim 13, wherein said the eCLE 10 provides after initialization 200 classification 210 capability for a set of characterized classes where (a) the supervised classifier 22 can identify known conditions as well as the (b) LVQ network 60, wherein when unsupervised learning 30 detects a new emerging behavior the is eCLE 10 goes to an adaptation stage where the LVQ 60 is expanded and the supervised classifier 22 is retrained.

15. The system according to claim 14, wherein the eCLE 10 provides a mechanism which results in a more powerful classifier to the one obtained by individual base classifier design or their agglomeration.

16. The system according to claim 15, wherein the eCLE 10 is not restricted to a specific application domain, wherein the eCLE can operate under uncertainty and perform pattern recognition; automated recognition and systematic processing of emerging behaviors; and adding new knowledge in a target system.

17. The system according to claim 3, wherein the supervised learning block and the unsupervised learning block operate in parallel over the same training data with the difference being the nature of the learning algorithms, wherein in the supervised learning, a pattern format 43 consists on an input vector (xₚ) and class ID as shown below,
$${p}_{p} = \{ {x}_{p} , Class\_Id \} = \{ [ \begin{matrix}{x}_{p , 1} \\ {x}_{p , 2} \\ ⋮ \\ {x}_{p , N}\end{matrix} ] , Class\_Id \} \qquad ( 1 )$$
and only the input feature vector xₚ 42 in the case of unsupervised learning.

18. The system according to claim 5, wherein the supervised learning block and the unsupervised learning block operate in parallel over the same training data with the difference being the nature of the learning algorithms, wherein in the supervised learning, a pattern format 43 consists on an input vector (xₚ) and class ID as shown below,
$${p}_{p} = \{ {x}_{p} , Class\_Id \} = \{ [ \begin{matrix}{x}_{p , 1} \\ {x}_{p , 2} \\ ⋮ \\ {x}_{p , N}\end{matrix} ] , Class\_Id \} \qquad ( 1 )$$
and only the input feature vector xₚ 42 in the case of unsupervised learning.

19. The system according to claim 16, wherein the supervised learning block and the unsupervised learning block operate in parallel over the same training data with the difference being the nature of the learning algorithms, wherein in the supervised learning, a pattern format 43 consists on an input vector (xₚ) and class ID as shown below,
$${p}_{p} = \{ {x}_{p} , Class\_Id \} = \{ [ \begin{matrix}{x}_{p , 1} \\ {x}_{p , 2} \\ ⋮ \\ {x}_{p , N}\end{matrix} ] , Class\_Id \} \qquad ( 1 )$$
and only the input feature vector xₚ 42 in the case of unsupervised learning.

20. A method of Embedded Collaborative Learning Engine (eCLE) which comprises a supervised learning block, an unsupervised learning block and an LVQ network, comprising the steps of:
(a) transferring available knowledge within a system through supervised learning, therefore available knowledge about classes and patterns is obtained;
(b) recognizing new clusters through unsupervised learning which allows cluster identification and characterization; and
(c) enabling autonomous learning and adaptation through embedding fast on-line learning algorithms such that a kernel with a plurality of preset learning schemes to which includes unsupervised, supervised, and hybrid learning schemes can be triggered and executed within a generalized framework, thereby an efficient scheme for enabling autonomous system evolution can be selectively provided.

21. The method according to claim 20, further comprising the substeps of:
(i) embedding knowledge by supervised learning;
(ii) performing unsupervised clustering;
(iii) transferring embedded knowledge to the unsupervised subsystem for optimizing unsupervised learning and for defining relations among clusters by using hybrid learning 60; and
(iv) operating in a collaborative fashion for blending both paradigms within a common generalized framework to achieve autonomous evolution.

22. The method according to claim 21, wherein the steps (i) and (ii) operate in parallel over the same training data 40 (i.e. same domain) with the difference being the nature of the learning algorithms.

23. The method according to claim 22, wherein in the supervised learning, a pattern format 43 consists on an input vector (xₚ) and class ID as shown below,
$${p}_{p} = \{ {x}_{p} , Class\_Id \} = \{ [ \begin{matrix}{x}_{p , 1} \\ {x}_{p , 2} \\ ⋮ \\ {x}_{p , N}\end{matrix} ] , Class\_Id \} \qquad ( 1 )$$
and only the input feature vector xₚ 42 in the case of unsupervised learning.
